(19) United States
(12) Patent Application Publication
(10) Pub. No.: US 2023/0214238 A1
(43) Pub. Date: Jul. 6, 2023

(54) CONTROLLING CLOUD MICROSERVICES AUTOMATICALLY

(71) Applicant: monday.com Ltd., Tel Aviv (IL)

(72) Inventors: Ben YITZHAKI, Ness Ziona (IL); Dan OFIR, Ganei Tikva (IL); David VIRTSER, Givatayim (IL)

(73) Assignee: monday.com Ltd., Tel Aviv (IL)

(21) Appl. No.: 17/565,758

(22) Filed: Dec. 30, 2021

(51) Int. Cl. G06F 9/451; G06F 9/54

(52) U.S. Cl. CPC G06F 9/451; G06F 9/547

(57) ABSTRACT

Methods and systems for controlling loosely-coupled services automatically, comprising instructing a Graphical User Interface (GUI) to present one or more configuration parameters for a command menu listing a plurality of commands corresponding to a plurality of actions for controlling one or more loosely-coupled services, for example, a microservice, a micro-frontend and/or the like of a cloud service facilitated by a container execution system, analyzing one or more commands inserted by the user(s) to determine one or more of the plurality of actions corresponding to the inserted command, and communicating with the container execution system via one or more networks to instruct automatic execution of the corresponding action(s) with respect to the one or more loosely-coupled services deployed as containers in the container execution system.

### BACKGROUND

The present invention, in some embodiments thereof, relates to controlling and managing cloud loosely-coupled services and, more specifically, but not exclusively, to automatically controlling and managing loosely-coupled services of a cloud service, for example, microservices, micro-frontends, and/or the like.

Distribution, deployment and usage of cloud services and web based applications is constantly increasing as cloud services have become a cornerstone for a plurality of applications spanning across almost all aspects of modern life, from finance and commercial markets, through data technology and design (e.g. software design) activities to gaming and leisure applications.

Managing and controlling the cloud services may be a challenging task in a plurality of aspects. One major challenge may relate to the ability to design the cloud service structure which may be extremely complicated and comprise a huge code base, in particular when constructed based on loosely-coupled services architecture, for example, microservices, micro-frontends and/or the like. Another challenge may be the ability to test and deploy the cloud service applications and loosely-coupled services without affecting the production environment of the cloud service where a plurality of users may be connected and using the cloud service.

### SUMMARY

According to a first aspect of the present invention there is provided a method of controlling loosely-coupled services automatically, comprising using one or more processors for:
Instructing a graphical user interface (GUI), executed by one or more client devices for interacting with one or more users, to present a command menu listing a plurality of commands corresponding to a plurality of actions for controlling one or more loosely-coupled services of a cloud service. The one or more loosely-coupled service are deployed as containers in a container execution system facilitating the cloud service.
Analyzing one or more commands inserted by the one or more users to determine one or more of the plurality of actions corresponding to the inserted command(s).
Communicating with the container execution system via one or more networks to instruct automatic execution of the corresponding one or more actions with respect to the one or more loosely-coupled services deployed in the container execution system.

According to a second aspect of the present invention there is provided a system for creating loosely-coupled services automatically, comprising one or more processors configured to execute a code. The code comprising:
Code instructions to instruct a graphical user interface (GUI), executed by one or more client devices for interacting with one or more users, to present a command menu listing a plurality of commands corresponding to a plurality of actions for controlling one or more loosely-coupled service of a cloud service, the one or more loosely-coupled services are deployed as containers in a container execution system facilitating the cloud service.
Code instructions to analyzing one or more commands inserted by the one or more users to determine one or more of the plurality of actions corresponding to the inserted command.
Code instructions to communicate with the container execution system via one or more networks to instruct automatic execution of the corresponding one or more actions with respect to the one or more loosely-coupled services deployed in the container execution system.

In a further implementation form of the first and/or second aspects, each of the one or more loosely-coupled services may be a member of a group comprising: a microservice and a micro-frontend.

In a further implementation form of the first and/or second aspects, the one or more loosely-coupled services are deployed in one or more geographical regions of a multi-region cloud service facilitated by a distributed container execution system deployed across a plurality of separate geographical regions of the multi-region cloud service.

In a further implementation form of the first and/or second aspects, the container execution system is based on Kubernetes.

In a further implementation form of the first and/or second aspects, the command menu further comprises one or more commands corresponding to one or more actions executed locally at a client device used by the one or more users.

In a further implementation form of the first and/or second aspects, operating the GUI, determining the corresponding one or more actions and communicating with the container execution system to instruct automatic execution of the corresponding one or more actions is done by a tool instantiated and executed by the client device according to one or more dotfiles.

In a further implementation form of the first and/or second aspects, the plurality of actions are members of a group consisting of: creating the one or more loosely-coupled services, connecting the one or more loosely-coupled services, locking deployment of the one or more loosely-coupled services, rolling-back the one or more loosely-coupled services, managing resources for the one or more loosely-coupled services, managing secrets for the one or more loosely-coupled services, managing services for the one or more loosely-coupled services, and/or initiating one or more scripts relating to the one or more loosely-coupled services.

In a further implementation form of the first and/or second aspects, creating the one or more loosely-coupled services comprises one or more of: deploying the one or more loosely-coupled services for testing in a staging environment of the container execution system, deploying the one or more loosely-coupled services in a production environment of the container execution system, monitoring the one or more loosely-coupled services deployed in the container execution system, and/or managing the one or more loosely-coupled services deployed in the container execution system.

In a further implementation form of the first and/or second aspects, connecting the one or more loosely-coupled services comprises connecting the one or more loosely-coupled services to a production environment of the container execution system.

In a further implementation form of the first and/or second aspects, locking of the one or more loosely-coupled service comprises one or more of: locking the one or more loosely-coupled services, unlocking the one or more loosely-coupled services, and/or transmitting one or more notifications indicative of a lock status of the one or more loosely-coupled services.

In a further implementation form of the first and/or second aspects, the cloud service comprises a multi-region cloud service facilitated by a distributed container execution system deployed across a plurality of separate geographical regions of the multi-region cloud service. The locking and/or unlocking is configured to support two operation modes: a regional lock mode in which one or more of the loosely-coupled services are locked and/or unlocked independently in one or more of the plurality of geographical regions, and a global lock mode in which one or more of the loosely-coupled services are locked and/or unlocked simultaneously in the plurality of geographical regions.

In a further implementation form of the first and/or second aspects, rolling-back the one or more microservice comprises: initiating a roll-back incident for rolling back one or more of the loosely-coupled services to a previous deployed version, and/or transmitting one or more notifications indicative of the roll-back incident.

In a further implementation form of the first and/or second aspects, the cloud service comprises a multi-region cloud service facilitated by a distributed container execution system deployed across a plurality of separate geographical regions of the multi-region cloud service. The rolling-back is configured to support two operation modes: a regional roll-back mode in which one or more of the loosely-coupled services are rolled-back independently in one or more of the plurality of geographical regions, and a global roll-back mode in which one or more of the loosely-coupled services are rolled-back simultaneously in the plurality of geographical regions.

In a further implementation form of the first and/or second aspects, managing resources for the one or more loosely-coupled services comprises one or more of: converting Application Programming Interface (API) instructions to one or more declarative configuration files used by the container execution system, instructing the container execution system to allocate one or more resources for the one or more loosely-coupled services, and/or instructing the container execution system to release one or more resources allocated for the one or more loosely-coupled services.

In a further implementation form of the first and/or second aspects, managing secrets for the one or more loosely-coupled services comprises one or more of: instructing the container execution system to create one or more secrets for use by the one or more loosely-coupled services, and/or instructing the container execution system to provide each secret value relating to the one or more loosely-coupled services.

In a further implementation form of the first and/or second aspects, managing services for the one or more loosely-coupled services comprises one or more of: instructing the container execution system to initiate one or more services used by the one or more loosely-coupled services, and/or instructing the container execution system to stop one or more services used by the one or more loosely-coupled services.

In a further implementation form of the first and/or second aspects, initiating one or more scripts relating to the one or more loosely-coupled services comprises instructing the container execution system to initiate the one or more scripts.

In a further implementation form of the first and/or second aspects, the GUI comprises a command line interface (CLI).

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of exemplary processes of automatically controlling and managing loosely-coupled services of a cloud service, according to some embodiments of the present invention;

FIG. 2 is a schematic illustration of an exemplary system for automatically controlling and managing loosely-coupled services of a cloud service, according to some embodiments of the present invention;

FIG. 3 is a schematic illustration of an exemplary tool chain for automatically controlling and managing loosely-coupled services of a cloud service, according to some embodiments of the present invention; and

FIG. 4 is a screenshot of a GUI operated by an exemplary microservice control tool configured to automatically control and manage loosely-coupled services of a cloud service, according to some embodiments of the present invention.

### DETAILED DESCRIPTION

The present invention, in some embodiments thereof, relates to controlling and managing cloud loosely-coupled services and, more specifically, but not exclusively, to automatically controlling and managing loosely-coupled services of a cloud service, for example, microservices micro-frontends, and/or the like.

Cloud services architecture constantly shifts towards loosely-coupled services rather than monolithic applications and services. Such cloud services may be constructed from a plurality of disparate services each having a significantly small footprint and a specific limited scope functionality that are loosely-coupled to each other via common interfaces and/or protocols to jointly achieve and support the overall functionality of the cloud service. However, while the loosely-coupled services may communicate with each other, each loosely-coupled service may be independent of the other loosely-coupled services such that changes, modifications, revisions, deployment, rollback and/or the like of one loosely-coupled service may not affect and/or influence any of the other loosely-coupled services.

The loosely-coupled services may be deployed across a plurality of layers of the cloud service, for example, a frontend of the cloud service, a backend and/or the like. For example, the loosely-coupled services may include microservices deployed and executed to utilize at least part of the backend layer of the cloud service which typically facilitates the data layer, the service logic and/or the like. In another example, the loosely-coupled services may include micro-frontends deployed and executed to utilize at least part of the frontend layer of the cloud service which typically facilitates the user interface, the access interface and/or the like.

Constructing the cloud service from a plurality of disparate loosely-coupled services as known in the art may introduce a plurality of benefits, as known in the art, for example, decentralized operation which may significantly reduce bottlenecks and improve performance, autonomous (independent) development and/or deployment (typically by deferent groups), reduced design complexity, efficient utilization of computing resources (e.g. processing resources, storage resources, etc.), use of different programming languages, databases, hardware and/or software environments, depending on what fits each service best and more.

According to some embodiments of the present invention, there are provided methods, systems, and computer program products for automatically controlling and managing loosely-coupled services, for example, a microservice, a micro-frontend and/or the like of a cloud service offering one or more applications, services, and/or the like to a plurality of users.

The cloud service may be typically utilized using virtualization technology, for example, Virtual Machines (VM) and moreover a virtualized container environment in which, services, applications, processes and/or workloads including loosely-coupled services may be executed as standalone containers (or Docker in Linux environment) which may be easily deployed and/or instantiated cross-platform, cross Operating System (OS) in the virtual environment practically independently of the host environment hosting of the cloud service.

For efficient deployment, execution, scalability and performance, the multi-region cloud service may be therefore facilitated by a container execution system, for example, Kubernetes and/or the like configured to provide an orchestration platform for managing containerized workloads, services and applications, including the loosely-coupled services.

The container execution system facilitating the cloud service may host and/or execute one or more edge proxy servers (frontend servers) deployed at the edge of the cloud service to provide and manage access to the cloud service, specifically to one or more application servers configured to execute one or more of the applications, services, datacenters, tools and/or utilities (collectively designated applications herein after) offered by the cloud service.

The edge proxy server(s) may receive a plurality of access requests from a plurality of users using respective client deices, for example, server, a computer, a laptop, a mobile device (e.g., Smartphone, tablet, etc.), and/or the like to access the cloud service. Functionality of the edge server(s), i.e., controlling, managing and/or routing the requests to the cloud service may therefore include, for example, ingress control, Domain Name Service (DNS), load balancing, reverse proxy and/or the like.

According to some embodiments the cloud service may be a multi-region cloud service globally accessible from a plurality of geographical regions which may typically include a primary geographical region and one or more secondary geographical regions. As described for the cloud service, the multi-region cloud service may be facilitated by a container execution system, in particular a distributed container execution system, for example, Kubernetes and/or the like distributed across the plurality of geographical regions to provide a multi-region orchestration platform for managing the containerized workloads, services and applications of the multi-region cloud service which may be implemented at least partially using loosely-coupled services.

Optionally, the cloud service and/or the multi-region cloud service, specifically the container execution system may be deployed and/or utilized using one or more cloud services, platforms and/or infrastructures, such as, for example, Amazon Web Service (AWS), Google Cloud, Microsoft Azure and/or the like. For example, one or more Virtual Private Clouds (VPC) may be deployed to facilitate the cloud service.

One or more developers using respective client devices, for example, a server, a computer, a laptop, a mobile device (e.g., Smartphone, tablet, etc.), and/or the like may control and manage one or more of the applications, services, tasks and/or workloads of the cloud service, specifically loosely-coupled services designed and deployed to establish the functional modules of the cloud service. Controlling and managing the loosely-coupled services may comprise, for example, creation, configuration, testing, deployment, execution, roll-back, termination and/or the like of one or more of the loosely-coupled services.

In particular, one or more of the developers may control and manage one or more of the loosely-coupled services using a microservice control tool configured to significantly automate the tasks involved in controlling and managing the loosely-coupled services. While the microservice control tool may be executed by one or more servers and/or cloud platforms, the microservice control tool may be optionally executed in the cloud service whose loosely-coupled services are created using the microservice control tool. The developer may use a local agent executed by his client device, for example, a web browser, a proprietary agent and/or the like to communicate and interact with the remote microservice control tool.

The microservice control tool may be configured to significantly automate control of the container execution system in which the loosely-coupled services are executed, in order to control and manage the loosely-coupled services, for example, create, configure, test, deploy, execute, roll-back, terminate and/or the like.

In particular, the microservice control tool may automatically control, for example, interact, configure, adjust and/or operate the container execution system according to rules, templates and/or domain knowledge for efficiently controlling and managing the loosely-coupled services in response to very high level instructions received from the developer(s).

The microservice control tool may communicate with the local agent executed by the developer's client device to operate and/or instruct a Graphical User Interface (GUI), for example, a command Line Interface (CLI) displayed on a screen of the client device to present a command menu to the developer. The command menu may include a plurality of commands, in particular high-level commands to enable the developer to select, indicate and/or initiate one or more of the listed commands.

Each of the commands listed in the command menu presented by the GUI may correspond and/or define one or more actions for controlling and/or managing the loosely-coupled services. However, while the commands may be high-level commands requiring minimal and typical almost no input from the developer, the corresponding actions may be highly flexible, comprehensive and extensive to enable accurate, efficient and robust control and management of the loosely-coupled services.

The microservice control tool may use and/or apply a plurality of rules, templates, domain knowledge and/or the like with respect to the commands selected by the developer to select, initiate and monitor corresponding actions such that the loosely-coupled services may be efficiently controlled automatically by the microservice control tool with very little intervention and/or input from the developer.

The microservice control tool may further communicate with the cloud service, in particular with the container execution system, for example, Kubernetes facilitating the cloud service in order to apply, initiate and/or instruct execution of the actions corresponding and/or defined by the commands selected by the developer.

The microservice create tool may use one or more interfaces, protocols, APIs and/or the like as known in the art to communicate with the container execution system. For example, assuming the container execution system is Kubernetes, the microservice create tool may use one or more interfaces, protocols, APIs and/or the like defined and/or applied by Kubernetes.

Automating the interaction, configuration and/or operation of the container execution system for controlling and managing the loosely-coupled services of the cloud service (and multi-region cloud service) may present major benefits and advantages compared to existing methods and systems for controlling services and applications of the cloud service in general and loosely-coupled services in particular.

First, the container execution system deployed to facilitate the could service and more so the distributed container execution system deployed to facilitate the multi-region cloud service may be highly complex as they may be configured to host and orchestrate an extremely large number of service and/or application instances. The complexity may further increase for a loosely-coupled services based cloud service since the container execution system may host and orchestrate an even larger number of loosely-coupled services which may be highly interdepended while each provides a limited scale functionality.

Interacting with the container execution system, for example, configuring, adjusting, operating and/or instructing it to support one or more of the actions for controlling and managing loosely-coupled services as may be done by the existing methods may require significant and typically extensive expertise, knowledge and/or experience. The need to be highly proficient and familiar with the container execution system may present a major limitation for developers who are developing loosely-coupled services. Automating the container execution system control may therefore relief the developers of the loosely-coupled services from the complex, and expertise demanding tasks of controlling the container execution system requiring them to only outline their general need and/or goal. The developers may therefore focus on designing, testing, deploying and monitoring their loosely-coupled services without the need to interact or even understand how the container execution system operates and/or configured.

Moreover, manually controlling the container execution system to execute one or more of the actions for controlling and managing loosely-coupled services may be highly inefficient, tedious, time consuming, non-scalable and prone to errors. In contrast, automating the interaction, configuration, adjustment and/or operation of the container execution system, on the other hand, may optimize the operation of the container execution system and, as result, optimize execution of the loosely-coupled services in terms of efficiency and/or performance, for example, reduced processing time, reduced latency and/or the like.

Furthermore, by automating the control and/or management of the container execution system may significantly optimize its execution and operation and as result optimize execution and/or operation of the loosely-coupled services. The cloud computing resources utilized by the loosely-coupled services, for example, processing resources, storage resources, networking resources and/or the like may be therefore significantly reduced.

In addition, automatically controlling the container execution system may be highly scalable to support highly complex, distributed and/or interdependent execution environments in which the container execution system may host and orchestrate extremely large numbers of loosely-coupled services, optionally distributed in a plurality of geographical regions.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

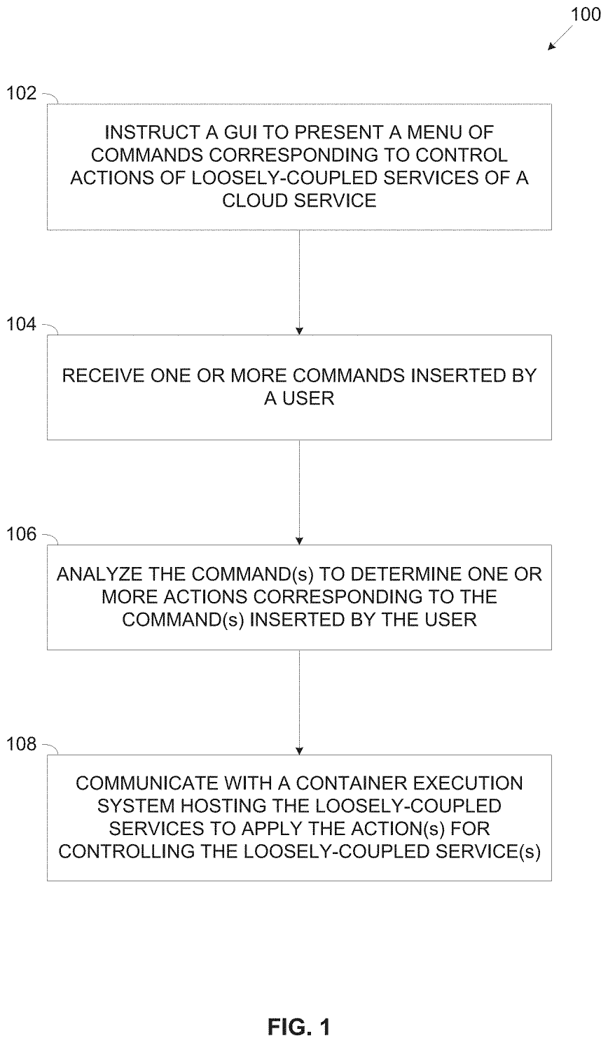

Referring now to the drawings, FIG. 1, which is a flowchart of exemplary processes of automatically controlling and managing cloud loosely-coupled services, according to some embodiments of the present invention.

An exemplary process 100 may be executed to interact with one or more users, in particular, developers, programmers and/or any authorized person (collectively designated developers herein after) to receive high level commands relating to one or more loosely-coupled services, for example, a microservice, a micro-frontend and/or the like of a cloud service and automatically initiating one or more actions corresponding and/or defined by the commands received from the developer(s).

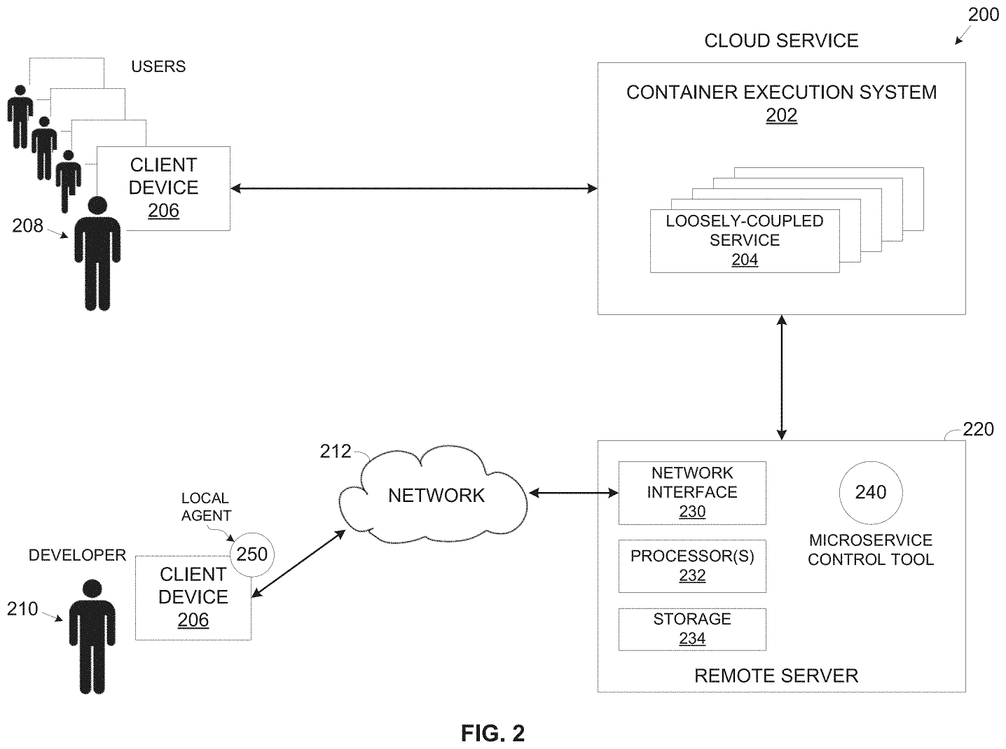

Reference is also made to FIG. 2, which is a schematic illustration of an exemplary system for automatically controlling and managing loosely-coupled services of a cloud service, according to some embodiments of the present invention.

An exemplary cloud service 200 may be configured to provide one or more cloud based services, for example, Infrastructure as a Service (IaaS), Platform as a Service (PaaS), Software as a Service (SaaS), Function as a Service (FaaS) and/or the like to one or more users 208 using one or more respective client devices 206 to access the cloud service 200.

The user(s) 208 using respective client device(s) 206, for example, a server, a computer, a laptop, a mobile device (e.g., Smartphone, tablet, etc.), a wearable device (e.g., smart watch, goggles, etc.) and/or the like may access the cloud service 200 via one or more wired and/or wireless networks, for example, a Local Area Network (LAN), a Wireless LAN (WLAN), a Wide Area Network (WAN), a Municipal Area Network (MAN), a cellular network, the internet and/or the like.

The cloud service 200 may typically include one or more edge proxy servers (frontend servers) and one or more application servers (backend servers). Deployed at the edge of the cloud service 200, the edge proxy server(s) may receive access requests originating from the users 208 using their client devices 206 and may be therefore configured to support one or more functions for managing the access requests, for example, ingress control, DNS, load balancing, reverse proxy and/or the like. The application server(s) (backend servers) may be configured to execute one or more applications, services, tools and/or utilities of the cloud service 200. While they may be executed by physical machines and hardware processors, the edge proxy server(s) and/or the application server(s) of the cloud service 200 may be typically implemented using virtualization technology, for example, virtual Machines (VM) instantiated over physical hardware.

In particular, the cloud service 200 may be facilitated by a container execution system 202, for example, Kubernetes and/or the like may be configured to provide an orchestration environment and platform for managing and executing containerized workloads, services and applications of the cloud service 200.

Optionally, the cloud service 200 may be utilized and/or deployed using one or more Virtual Private Clouds (VPC) facilitated and/or provided by one or more cloud platforms, infrastructures and/or services, such as, for example, Amazon Web Service (AWS), Google Cloud, IBM Cloud, Microsoft Azure and/or the like.

The edge proxy server(s) may be communicatively coupled to the application server(s) via one or more intra-region networking infrastructures which may comprise one or more physical networks and/or one or more VPC networks facilitated by the container execution system 202. The communication between the edge proxy server(s) and the application server(s) may be also based on routing tables defined for the VPC(s).

The container execution system 202 may therefore control, manage and/or orchestrate execution of a plurality of loosely-coupled services 204 of the cloud service 200. The plurality of loosely-coupled services 204 of the cloud service 200, for example, microservices, micro-frontends and/or the like, may be deployed and executed as containers (e.g. Dockers, etc.) in the container execution system 202 to facilitate at least part of the functionality of the edge proxy server(s) and/or the application server(s) of the cloud service 200.

According to some embodiments of the present invention, the cloud service 200 may be a multi-region cloud service deployed to provide region based applications (services) to a plurality of users 208 located in a plurality of geographical regions. The geographical regions may be divided according to one or more division paradigms, for example, geography, law and/or regulation enforcement, politics, economics, finance division, culture and/or the like, for example, north America, south America, western Europe, eastern Europe, north Africa, middle east, southeast Asia, Australia and/or the like.

The multi-region cloud service may be also facilitated by a container execution system such as the container execution system 202 in particular, a distributed container execution system, for example, Kubernetes and/or the like distributed across the plurality of geographical regions. The distributed container execution system, for example, Kubernetes and/or the like may be configured to provide a multi-region orchestration environment and platform for managing containerized loosely-coupled services 204 independently and optionally in isolation in each of the geographical regions to support the multi-region cloud service.

In addition to being able to communicate with application server(s) deployed in its geographical regions via the intra-region networking infrastructure(s), each edge proxy server may be further configured to communicate with one or more other edge proxy servers deployed in one or more other (different) geographical regions, via one or more inter-region networking infrastructures. The inter-region networking infrastructures may be based on one or more physical networks, one or more virtual networks and/or a combination thereof. The virtual networks may be based on one or more peering connections, tunnels, Virtual Private Network (VPN) connections and/or the like facilitated by the distributed container execution system. For example, in case the distributed container execution system 202A is deployed using AWS, one or more AWS transit gateways may be used to connect between edge proxy server(s) deployed in different geographical regions.

One or more developers 210 using one or more client devices such as the client device 206, for example, a server, a computer, a laptop and/or the like may use a microservice control tool 240 to control and manage, mostly automatically, one or more of the loosely-coupled services 204 of the cloud service 200 executed as containers in the container execution system 202.

The microservice control tool 240 may be executed remotely by a remote server 220. The developer(s) 210 using his client device(s) 206 may therefore communicate with the remote server 220 via a network 212 comprising one or more wired and/or wireless networks, for example, a LAN, a WLAN, a WAN, a MAN, a cellular network, the internet and/or the like.

The remote server 220, for example, a server, a computing node, a cluster of computing nodes and/or the like may comprise a network interface 230 for connecting to the network 212, a processor(s) 232 for executing the process 100, and a storage 234 for storing data and/or code (program store).

The network interface 230 may include one or more wired and/or wireless network interfaces for connecting to the network 212, for example, a LAN interface, a WLAN interface, a WAN interface, a MAN interface, a cellular interface and/or the like. Via the network interface 230, the remote server 220 may communicate with the client device(s) 206 of the developer(s) 210. Moreover, via the network 212, the remote server 220 may communicate with the cloud service 200, specifically with the container execution system 202.

The processor(s) 232, homogenous or heterogeneous, may include one or more processing nodes and/or cores arranged for parallel processing, as clusters and/or as one or more multi core processor(s). The storage 234 may include one or more non-transitory persistent storage devices, for example, a Read Only Memory (ROM), a Flash array, a Solid State Drive (SSD), a hard drive (HDD) and/or the like. The storage 242 may also include one or more volatile devices, for example, a Random Access Memory (RAM) component, a cache and/or the like. The storage 234 may further comprise one or more local and/or remote network storage resources, for example, a storage server, a Network Attached Storage (NAS), a network drive, a cloud storage service and/or the like accessible via the network interface 230.

The processor(s) 232 may execute one or more software modules each comprising a plurality of program instructions stored in a non-transitory medium (program store) such as the storage 232 and executed by one or more processors such as the processor(s) 230. Optionally, the processor(s) 230 may include and/or utilize one or more hardware elements integrated in the remote server 220, for example, a circuit, a component, an Integrated circuit (IC), an Application Specific Integrated Circuit (ASIC), a Field Programmable Gate Array (FPGA), a Digital Signals Processor (DSP), a Graphic Processing Unit (GPU), an Artificial Intelligence (AI) accelerator and/or the like. The processor(s) 232 may therefore execute one or more software modules utilized by one or more software modules, one or more hardware modules and/or a combination thereof, for example, the microservice control tool 240.

Optionally, the remote server 220, specifically the microservice control tool 240 may be utilized by one or more cloud computing services, platforms and/or infrastructures such as, for example, IaaS, PaaS, SaaS and/or the like provided by one or more vendors, for example, Google Cloud, Microsoft Azure, AWS, Elastic Compute Cloud (EC2) and/or the like. Moreover, the microservice control tool 240 may be utilized by the cloud service 200 optionally executed in the container execution system 202.

The microservice control tool 240 may be configured to significantly automate the interaction, configuration and/or operation of the container execution system 202 in which the loosely-coupled services 204 are executed in order to control and manage the loosely-coupled services 204, for example, create, configure, test, deploy, execute, roll-back, terminate and/or the like. In particular, the microservice control tool 240 may automatically interact, configure and/or operate the container execution system 202 according to rules, templates and/or domain knowledge for efficiently controlling the loosely-coupled services 204 in response to very high level instructions of the developer(s) 210.

The microservice control tool 240 may thus relief the developer(s) 210 from the complex, tedious and expertise demanding tasks of interacting, controlling, configuring, adjusting and/or operating the container execution system 202. The developers 210 may therefore focus on designing, testing, deploying and monitoring their loosely-coupled services 204 without the need to interact and even understand how the container execution system 202 operates and/or configured.

Each developer 210 using a client device 206 may interact and communicate with the microservice control tool 240 via a local agent 250 executed by the client device 206, for example, a web browser (e.g., chrome, Firefox, Opera, Microsoft Edge, etc.), a local agent, an access utility and/or the like configured to access the remote server 220 and interact with the remote microservice control tool 240.

The microservice control tool 240 communicating with the local agent 250 may instruct the local agent 250 to operate a Graphical User Interface (GUI), for example, a Command Line Interface (CLI) and/or the like presented via a user interface of the client device 206, for example, displayed on a screen, played via a speaker and/or the like for interacting with the developer 210.

The GUI may be integrated in the local agent 250 or separated from it and controlled by one or more other GUI control modules, for example an OS executed by the client device 206, a display application, driver, tool and/or the like. In such case, the local agent 250 may communicate with the GUI control module(s) via one or more interfaces, channels, messages, API and/or the like facilitated by the software execution environment of the client device 206 to instruct operation of the GUI.

Via the local agent 250, the microservice control tool 240 may instruct the GUI to present a command menu to the developer 210. The command menu may include a plurality of commands, in particular high-level commands each corresponding and/or defining one or more actions for controlling and/or managing one or more of the loosely-coupled services 204, for example, creating, configuring, testing, deploying, executing, rolling-back, terminating and/or the like.

The developer 210 interacting with GUI via the user interface of the client device 206, for example, a keyboard, a pointing device and/or the like may select one or more of the commands. In response to the command(s) inserted by the developer 210, the microservice control tool 240 may initiate the action(s) corresponding and/or defined by the received command(s).

The microservice control tool 240 may further communicate with the cloud service 200, in particular with the container execution system 202, for example, Kubernetes facilitating the cloud service 200 in order to apply, initiate and/or instruct execution of the actions corresponding and/or defined by the commands selected by the developer 210.

The local agent 250 executed by the client device 206 to communicate with the microservice control tool 240 may be implemented according to one or more design architectures, implementations and/or deployments. For example, the microservice control tool 240 may be implemented as a web application, a web page and/or the like hosted by one or more remote computing nodes, for example, server, a cloud service and/or the like. In such case, the client device 206 may execute the local agent 250, for example, a web browser (e.g., chrome, Firefox, Opera, Microsoft Edge, etc.), a local agent, an access utility and/or the like for browsing to the remote server 220 and communicating with the remote microservice control tool 240. In another example, the microservice control tool 240 may be provided as a Software Development Kit (SDK) exposing an API of the microservice control tool 240 which may be used by one or more other software modules executed by the client device 206 of the developer 210 to communicate with the microservice control tool 240.

Moreover, the local agent 250 used to communicate with the microservice control tool 240 may be installed, instantiated, configured and/or executed according to one or more dotfiles. The dotfile(s) may be designed and configured to automatically install the local agent 250 on the client device 206 used by the developer 210, for example, when opening a new terminal. The dotfile(s) may further allow control of the terminal used by the developer 210 making it easier to perform operations which may be potentially done automatically and/or with insignificant user intervention, for example, install one or more tools in advance, configure and enable permissions for one or more particular services, connect to the container execution system 202. The dotfile(s) may be further designed and configured to automatically replicate (clone) a local repository of one or more loosely-coupled services 204 on the client device 206 used by the developer 210. As such the entire process of installing the microservice control tool 240 may be practically automatic up to the point where the developer 210 is requested to provide his username and password.

In the multi-region cloud service embodiments, the microservice control tool 240 may be configured to support creation and control of loosely-coupled services 204 deployed in the distributed container execution system in any of the geographical regions of the multi-region cloud service.

In case the microservice control tool 240 is utilized by the multi-region cloud service itself, the micro service control tool 240 may be typically deployed in a single geographical region of the multi-region cloud service, for example, a primary geographical region. However, using distribution resources, means, applications and/or protocols deployed and/or executed by the distributed container execution system 202A, the microservice control tool 240 may further control and manage loosely-coupled services 204 deployed and executed in the other (secondary) geographical regions of the multi-region cloud service. Such distribution resources, means, applications and/or protocols are outside the scope of this disclosure.

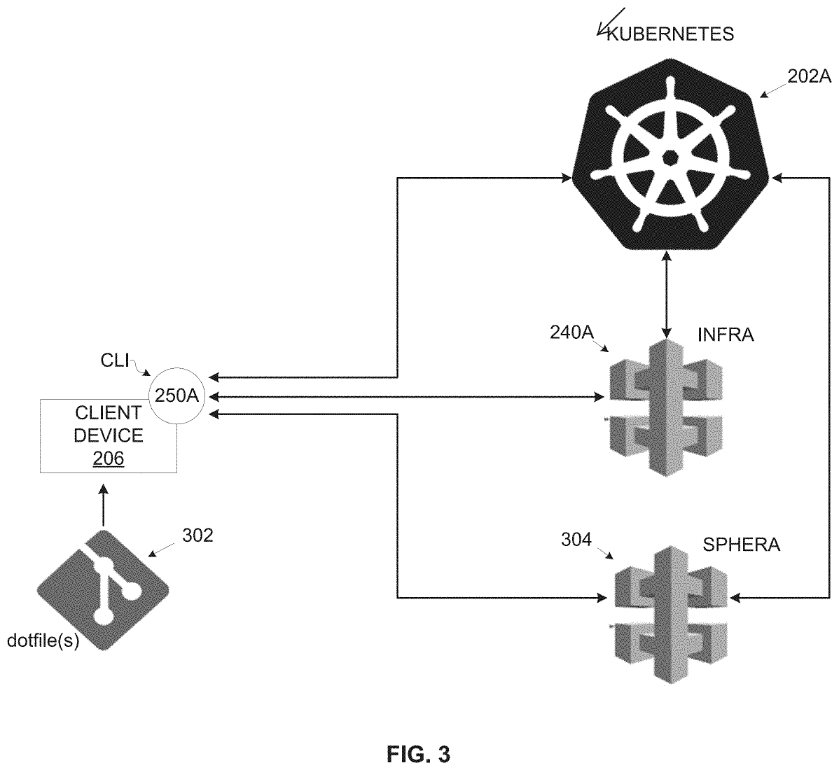

Reference is now made to FIG. 3, which is a schematic illustration of an exemplary tool chain for automatically controlling and managing loosely-coupled services of a cloud service, according to some embodiments of the present invention.

An exemplary microservice control tool 240, for example, Infra tool 240A by monday.com, may be used to automatically control and manage one or more loosely-coupled services such as the loosely-coupled services 204 of a cloud service such as the cloud service 200. In particular, the loosely-coupled services 204 may be executed as containers in a container execution system such as the container execution system 202, for example, a Kubernetes cluster 202A.

A local agent such as the local agent 250, for example, a CLI tool by monday.com may be executed by a client device such as the client device 206 used by a developer such as the developer 210 to interact and communicate with the Infra tool 240A configured to automate control and/or management one or more loosely-coupled services 204 of the cloud service 200. For, example, via the CLI tool, the Infra tool 240A may be instructed to rollback one or more of the loosely-coupled services 204.

Moreover, via the CLI tool, the developer 210 may further interact and communicate with one or more other applications, tools and/or platforms, for example, a Sphera tool 304 by monday.com configured to automate creation and staging of one or more of the loosely-coupled services 204 of the cloud service 200. For, example, via the CLI tool, the Sphera tool 240A may be instructed to create one or more new loosely-coupled services 204.

One or more dotfiles may be used to configure the client device 206 of the developer 210 and/or the local agent 250 for operation with the Sphera tool 240A and/or with the Infar tool 304. For example, the dotfile(s) may be designed and configured to support, configure and/or guide automatic replication of a repository of the created loosely-coupled services 204 on the client device 206 to create a local copy of the repository.

Optionally, the local agent 250, for example, the CLI tool may directly communicate with the container execution system 202, for example, the Kubernetes cluster 202A to transmit and/or receive data relating to one or more of the actions executed with respect to one or more of the loosely-coupled services 204. For example, the CLI tool may communicate with the Kubernetes cluster 202A to connect one or more of the loosely-coupled service 204 as described herein before. The connect command may require authentication of the user, i.e., the developer 210. The connect command may be therefore enhanced to include authentication data of the developer 210, for example, username, credentials and/or the like. Continuing this example, in return to the connect command, the Kubernetes cluster 202A may respond to the CLI tool with a connection to a desired pod.

Reference is made once again to FIG. 1.

For brevity, the exemplary process 100 is described for a single developer 210 using a single client device 206 executing a local agent 250 to interact with a single instance of the microservice control tool 240 to control and manage a single loosely-coupled service 204 of the cloud service 200. This, however, should not be construed as limiting, since, as may be apparent to a person skilled in the art, the process 100 may be easily replicated and scaled to a plurality of developers 210 using a plurality of client devices 206 to interact with a plurality of instances of the microservice control tool 240 for controlling and managing a plurality of loosely-coupled services 204 of the cloud service 200 and further of a plurality of cloud services 200. Naturally, access, control, and management of the loosely-coupled services 204 may be subject to authorization, authentication and optionally to security policies and/or access privileges applied on the developers 210.

Furthermore, while the description of the process 100 addresses the cloud service 200, the same applies for the multi-region cloud service. There may be aspects and/or features unique to the multi-region cloud service 200A, specifically with respect to its multi-region nature which may be further discussed in the description.

As shown at 102, the process 100 starts with the microservice control tool 240 communicating with the local agent 250 to instruct the GUI to present on the screen of the client device 206 used by the developer 210 a command menu listing a plurality of commands for controlling and managing one or more of the loosely-coupled services 204 of the cloud service 200 and/or multi-region cloud service 200A.

The GUI controlled according to instructions received from the microservice control tool 240 may be constructed using one or more architectures, designs and/or visual interfaces, for example, a Command Line Interface (CLI) and/or the like.

Each of the commands may correspond and/or define one or more actions to control and/or manage, for example, create, configure, test, deploy, execute, roll-back, terminate and/or the like of one or more of the loosely-coupled services 204 thus enabling the developer 210 to select one or more of the commands and initiate the corresponding and/or defined actions in order to control and manage the loosely-coupled services 204.

Specifically, the commands may be high-level commands requiring very little input and very little understanding of the container execution system 202 from the user, i.e., the developer 210 thus enabling the developer 210 to efficiently and effortlessly control and manage the loosely-coupled services 204 without having significant expertise, knowledge and/or experience in the workings of the container execution system 202. Each of the commands may therefore require only very few configuration parameters, for example, up to three, five, or ten parameters for configuring the action corresponding to the respective command and/or selecting action's options.

While the commands may be high-level commands requiring minimal and typical almost no input from the developer 210, the corresponding actions may be highly flexible, comprehensive and extensive to enable accurate, efficient and robust control and management of the loosely-coupled services 204. The microservice control tool 240 may use and/or apply a plurality of rules, templates, domain knowledge and/or the like to select, initiate and monitor the corresponding actions such that the loosely-coupled services 204 may be efficiently controlled with very little intervention and/or input from the developer 210.

Using the GUI, the developer 210 using the user interface 236 of the client device 206, for example, the keyboard may select one or more of commands and optionally one or more of its configuration parameter(s) (if applicable) to initiate the action(s) corresponding to the selected command(s) in order to control and/or manage one or more of the loosely-coupled services 204.

As shown at 104, the microservice control tool 240 may receive the command(s) inserted by the developer 210 and the loosely-coupled service(s) 204 to which the command(s) is directed. One or more of the commands may be further received with values for one or more of its configuration parameters is available.

In particular, the local agent 250 may receive the command(s) inserted by the developer 210 using the GUI and may forward the received command(s) and optionally the configuration parameters to the microservice control tool 240 via the network 212.

As shown at 106, the microservice control tool 240 may analyze the received command(s) and optionally the configuration parameter(s) if available to determine the action(s) corresponding to the command(s) selected by the user, i.e., the developer 210 and identify the loosely-coupled service(s) 204 to which the command(s) relate.

As shown at 108, the microservice control tool 240 may communicate with the container execution system 202, for example, Kubernetes to instruct the container execution system 202 to configure, operate and/or instruct the container execution system 202 in order to control the loosely-coupled service(s) 204 indicated by the developer 210 by executing and/or applying automatically the action(s) corresponding to the command(s) selected by the developer 210.

The microservice control tool 240 may use one or more interfaces, protocols, APIs and/or the like as known in the art to communicate with the container execution system 202. For example, assuming the container execution system 202 is utilized by Kubernetes, the microservice control tool 240 may use one or more interfaces, protocols, APIs and/or the like defined and/or applied by Kubernetes.

In case of the multi-region cloud service 200A, the microservice control tool 240 may communicate with resources of the distributed container execution system 202A deployed in the primary geographical region 204 regardless of whether the indicated loosely-coupled service(s) 204 is executed and/or deployed in the primary geographical region 204 and/or in one or more of the other (secondary) geographical regions 204 of the multi-region cloud service 200A.

As such, the microservice control tool 240 may instruct the distributed container execution system 202A, specifically its resources deployed in the primary geographical region 204 to configure, operate and/or instruct the distributed container execution system 202A in order to execute and/or apply automatically the action(s) corresponding to the selected command(s) with respect to indicated loosely-coupled service(s) 204 which may be executed and/or deployed in one or more of the geographical regions 204 of the multi-region cloud service 200A.

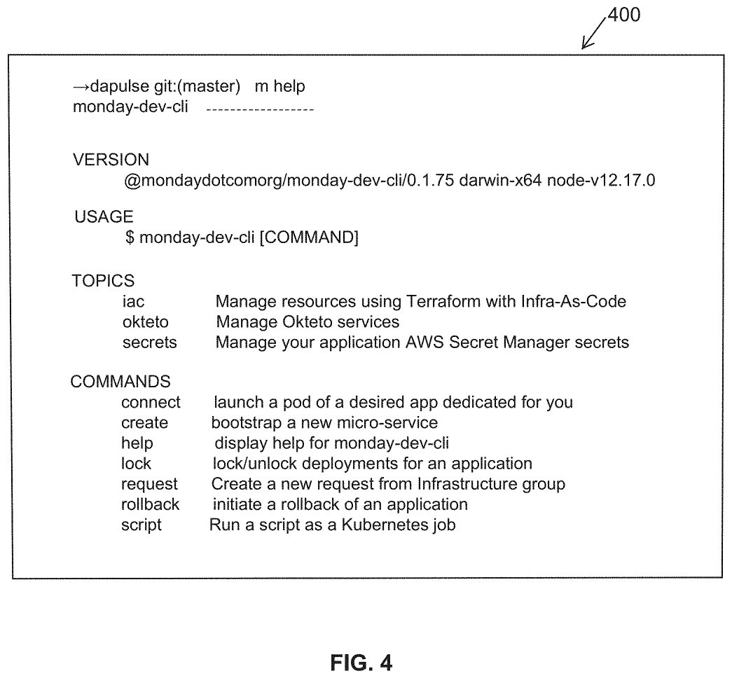

Reference is now made to FIG. 4, which is a screenshot of a GUI operated by an exemplary microservice control tool configured to control and manage automatically loosely-coupled services of a cloud service, according to some embodiments of the present invention.

A screenshot 400 of a GUI operated according to instructions received from an exemplary microservice control tool such as the microservice control tool 240 via a local agent such as the local agent 250. The GUI, for example, a CLI may be operated to present a command menu listing a plurality of commands on a screen of one or more client devices such as the client device 206 used by one or more developers such as the developer 210.

The microservice control tool 240 may be configured to automate control and/or management of one or more loosely-coupled services such as the loosely-coupled services 204 of a cloud service such as the cloud service 200 facilitated by a container execution system such as the container execution system 202.

In particular, the microservice control tool 240 may significantly automate interaction with and/or control of a container execution system such as the container execution system 202 according to one or more rules, templates and/or knowledge domain information in order to control and manage one or more loosely-coupled services such as the loosely-coupled service 204 of the cloud service 200 as requested by one or more of the developers 210.

The microservice control tool 240 may be further configured to automate control of a distributed container execution system such as the distributed container execution system 202A in order to configure, operate and/or instruct the container execution system 202 to control and manage the loosely-coupled services 204 of the multi-region cloud service 200A.

The actions for controlling and managing the loosely-coupled services 204 may include a plurality of actions relating to creation, configuration, testing, deployment, execution, roll-back, termination and/or the like of one or more of the loosely-coupled services 204.

For example, one or more actions corresponding to a create command listed in the command menu may be executed and/or applied for creating one or more loosely-coupled services 204. The create actions may include, for example, constructing a new loosely-coupled service 204 by automatically creating a repository for the new loosely-coupled service 204, for example, a GitHub repository and importing into the repository one or more code segments required for the new loosely-coupled service 204. The code segment(s) may be selected according to one or more rules and/or templates based on one or more configuration parameters selected by the developer 210 while interacting with the GUI to select the create command. However, one or more of the code segments included in the repository of the new loosely-coupled service 204 may be selected by default, for example, in case no explicit indication is received from the developer 210.

The create actions may also include adding resource definitions for the new loosely-coupled service 204 for later creation, for example, one or more databases, one or more queues, one or more alarms and/or the like.

The create actions may further include deploying automatically the newly created loosely-coupled service 204 for testing in a staging environment of the container execution system 202. The staging environment may be completely isolated and/or transparent to the production environment of the container execution system 202 which is the operational environment facilitating the cloud service 200. As such, executing loosely-coupled services 204 in the staging environment may not affect, impact and/or degrade execution in the production environment thus ensuring that testing the created loosely-coupled services 204 may not influence the production environment. The create actions may also include automatic deployment of the created loosely-coupled service 204 in the production environment of the container execution system 202, for example, after the created loosely-coupled service 204 is tested and its proper operation is successfully verified and/or validated.

Moreover, the create actions may comprise initiating and/or executing one or more monitoring tasks, modules and/or services for monitoring one or more activities and/or metrics of the created loosely-coupled service 204 after deployed in the container execution system 202, for example, Kubernetes, either in the staging environment and/or in the production environment.

One or more of the create actions may further initiated and/or executed for managing one or more of the loosely-coupled services 204 deployed in the container execution system 202, for example, allocate resources (e.g. database, message queue, alarm, etc.), manage access privileges (individuals, groups, access type, etc.) and/or the like.

In another example, one or more actions corresponding to a connect command listed in the command menu may be executed and/or applied for connecting to one or more of the loosely-coupled services 204. Connecting to a loosely-coupled service 204 may include creating and instantiating one or more instances of an existing loosely-coupled service 204 in the staging and/or production environments of the container execution system 202 in one or more of the geographical regions 204 of the multi-region cloud service 200A.

Optionally, in case a newer version of the instantiated loosely-coupled service 204 exists, the microservice control tool 240 may instruct and/or operate the GUI, via the local agent 250, to issue a visual indication, for example, a message and/or the like to notify the developer 210 of the newer version.

Connecting a loosely-coupled service 204 to the staging environment and/or the production environment of the container execution system 202 may require authentication of the developer 210. For example, assuming the container execution system 202 is utilized by the AWS platform, an aws-login-prod may be applied to authenticate the developer 210 connecting to the production environment and an aws-login-sandbox may be applied to authenticate the developer 210 connecting to the staging environment.

In another example, one or more actions corresponding to a lock command listed in the command menu may be executed and/or applied for locking and/or unlocking one or more of the loosely-coupled service 204 and/or one or more of their objects (e.g., resources, pipelines, etc.) and updating their state of to “lock” or “unlock” status accordingly. The lock actions may further include saving the locked loosely-coupled service(s) 204 and/or its object(s) in one or more databases to ensure its persistence.

The lock actions may further include generating, for example, transmitting, outputting and/or the like one or more notifications indicative of the “lock/unlock” status of one or more of the loosely-coupled services 204.

The lock actions may support locking and/or unlocking the loosely-coupled service(s) 204 and/or its object(s) according to one or more lock operation modes. For example, a regional lock mode may be applied to lock or unlock a specific loosely-coupled service 204 independently in one or more of the geographical regions 204 of the multi-region cloud service 200A. In another example, a global lock mode may be applied to lock or unlock a specific loosely-coupled service 204 simultaneously in all of the geographical regions 204. Moreover, a complete regional lock mode may be applied to lock or all of the loosely-coupled services 204 in each of one or more of the geographical regions 204 of the multi-region cloud service 200A. in another example, a complete global lock mode may be applied to lock or all of the loosely-coupled services 204 in all of the geographical regions 204.

Furthermore, the lock operations modes may further include a deployment lock which may be applied during one or more deployments and removed once the deployment finishes in success or failure.

In another example, one or more actions corresponding to a rollback command listed in the command menu may be executed and/or applied for initiating a roll-back incident for rolling back one or more of the loosely-coupled services 204 to its previous deployed version, i.e., the previous version of the respective loosely-coupled service 204 deployed in the container execution system 202. The roll-back actions may further include generating, for example, transmitting, outputting and/or the like one or more notifications indicative of the roll-back incident.

The roll-back actions may support rolling-back a loosely-coupled service 204 according to two operation modes. A first operation mode may be a regional roll-back in which the loosely-coupled service 204 may be rolled-back independently in one or more of the geographical regions 204 of the multi-region cloud service 200A. A second operation mode may be a global roll-back in which the loosely-coupled service 204 may be rolled-back simultaneously in all of the geographical regions 204.

In another example, one or more actions corresponding to a resource management (iac) command listed in the command menu may be executed and/or applied for managing resources for one or more of the loosely-coupled services 204. The resource management actions may include, for example, converting API instructions to one or more declarative configuration files used by the container execution system 202. In another example, the resource management actions may include instructing the container execution system 202 to allocate one or more resources, for example, a database, a queue, an alarm and/or the like for one or more of the loosely-coupled services 204. In another example, the resource management actions may include instructing the container execution system 202 to release one or more resources allocated for one or more of the loosely-coupled services 204.

The source management actions may therefore support creating resource definition files which may be added into an existing code base that may exist locally at the client device 206 used by the developer 210. That way, complex infrastructures may be added automatically to new and/or existing loosely-coupled services 204 with very little and potentially no knowledge required by the developer 210 on the code that creates the infrastructure. This may be regarded as importing one or more complex infrastructures to replace corresponding placeholders in one or more templates stored at the client device 206 to facilitate one or more of the loosely-coupled services 204.

In another example, one or more actions corresponding to a secret management (secrets) command listed in the command menu may be executed and/or applied for managing secrets for one or more of the loosely-coupled services 204. The resource management actions may include, for example, instructing the container execution system 202 to create one or more secrets for use by one or more of the loosely-coupled services 204. In another example, the resource management actions may include instructing the container execution system 202 to provide each secret value relating to one or more of the loosely-coupled services 204.

Moreover, the secret management operations may support generating one or more global secrets which may be shared by instances of one or more loosely-coupled services 204 deployed and executed in a plurality of geographical regions 204 of the multi-region cloud service 200A. However, the secret management operations may also support generating one or more regional secrets which may be each used by one or more loosely-coupled services 204 deployed and executed in single one of the geographical regions 204.

In another example, one or more actions corresponding to a service management (okteto) command listed in the command menu may be executed and/or applied for managing one or more services used by one or more of loosely-coupled services 204. The service management actions may include, for example, instructing the container execution system 202 to initiate one or more services to be used by one or more of the loosely-coupled services 204. In another example, the resource management actions may include instructing the container execution system 202 to stop one or more services used by one or more of the loosely-coupled services 204. For example, one or more external service, for example, development services such as, for example, okteto and/or the like may be used to develop one or more of the loosely-coupled services 204. The service management command may therefore provide simple and direct access for the developer 210 to the external services.

In another example, one or more actions corresponding to a script command listed in the command menu may be executed and/or applied for initiating, specifically for instructing the container execution system 202 to initiate one or more scripts relating to one or more of loosely-coupled services 204. The script actions may be directed to instruct the container execution system 202 to execute (run) one or more specific segments of code that exists already in one of the loosely-coupled services 204 which have been deployed previously. In particular, the script actions may instruct the container execution system 202 to execute the indicated code segments in a separate machine which may be created for the purpose of the execution of the script. It may be regarded as an extended create action further comprising executing (running) specific commands. The scripts may be used by the developer 210 for one or more tasks, for example, maintenance tasks which he may want to perform manually.

Optionally, the command menu may further list one or more commands corresponding to one or more actions executed locally at the client device 206 used by the developer 210. For example, a certain command listed in the command menu may correspond to one or more actions directed to create one or more new loosely-coupled services 204 independently of the container execution system 202, for example, directly on GitHub, on one or more other third party servers and/or locally on the client device 206 of the developer 210. This may enable the developer 210 to locally control the loosely-coupled service(s) 204, for example, modify the loosely-coupled service(s) 204 (e.g. add/remove/amend code) according to a fixed structure. In another example, the developer 210 may select commands corresponding to locally executed actions to add one or more resources to one or more of the loosely-coupled services 204 and manage it using code. In another example, the developer 210 may select commands corresponding to locally executed actions to produce one or more databases in a local project maintained at the client device 206 used by the developer 210 which may be ready for work instead of manually creating a project.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms loosely-coupled services, virtualization, container, container execution system, VPC, cloud intra-region network, and cloud inter-region network are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A method of controlling loosely-coupled services automatically, comprising:
using at least one processor for:
instructing a graphical user interface (GUI), executed by at least one client device for interacting with at least one user, to present a command menu listing a plurality of high-level commands corresponding to a plurality of actions for controlling and managing an operation of at least one loosely-coupled service of a cloud service according to at least one of rules, templates and domain knowledge, wherein said controlling and managing comprise at least one of configuring, adjusting and operating said at least one loosely-coupled service, wherein the at least one loosely-coupled service is deployed as a container in a container execution system facilitating the cloud service;
receiving a selection of one of the plurality of high-level commands selected by the at least one user using the GUI;
analyzing at least one command inserted by the at least one user by said selection, to determine at least one of the plurality of actions corresponding to the at least one inserted command; and
communicating with the container execution system via at least one network to instruct automatic execution of the corresponding at least one action with respect to the at least one loosely-coupled service deployed in the container execution system.

2. The method of claim 1, wherein the at least one loosely-coupled service is a member of a group comprising: a microservice, and a micro-frontend.

3. The method of claim 1, wherein the at least one loosely-coupled service is deployed in at least one geographical region of a multi-region cloud service facilitated by a distributed container execution system deployed across a plurality of separate geographical regions of the multi-region cloud service.

4. The method of claim 1, wherein the container execution system is based on Kubernetes.

5. (canceled)

6. The method of claim 1, wherein operating the GUI, determining the corresponding at least one action and communicating with the container execution system to instruct automatic execution of the corresponding at least one action is done by a tool instantiated and executed by the client device according to at least one dotfile.

7. The method of claim 1, wherein the plurality of actions are members of a group consisting of: creating the at least one loosely-coupled service, connecting the at least one loosely-coupled service, locking deployment of the at least one loosely-coupled service, rolling-back the at least one loosely-coupled service, managing resources for the at least one loosely-coupled service, managing secrets for the at least one loosely-coupled service, managing services for the at least one loosely-coupled service, and initiating at least one script relating to the at least one loosely-coupled service.

8. The method of claim 7, wherein creating the at least one loosely-coupled service comprises at least one of:
deploying the at least one loosely-coupled service for testing in a staging environment of the container execution system,
deploying the at least one loosely-coupled service in a production environment of the container execution system,
monitoring the at least one loosely-coupled service deployed in the container execution system, and
managing the at least one loosely-coupled service deployed in the container execution system.

9. The method of claim 7, wherein connecting the at least one loosely-coupled service comprises connecting the at least one loosely-coupled service to a production environment of the container execution system.

10. The method of claim 7, wherein locking of the at least one loosely-coupled service comprises at least one of:
locking the at least one loosely-coupled service,
unlocking the at least one loosely-coupled service, and
transmitting at least one notification indicative of a lock status of the at least one loosely-coupled service.

11. The method of claim 10, wherein the cloud service comprises a multi-region cloud service facilitated by a distributed container execution system deployed across a plurality of separate geographical regions of the multi-region cloud service, the locking and/or unlocking is configured to support two operation modes:
a regional lock mode in which the at least one loosely-coupled service is locked and/or unlocked independently in at least one of the plurality of geographical regions, and
a global lock mode in which the at least one loosely-coupled service is locked and/or unlocked simultaneously in the plurality of geographical regions.

12. The method of claim 7, wherein rolling-back the at least one loosely-coupled service comprises:
initiating a roll-back incident for rolling back the at least one loosely-coupled service to a previous deployed version, and
transmitting at least one notification indicative of the roll-back incident.

13. The method of claim 12, wherein the cloud service comprises a multi-region cloud service facilitated by a distributed container execution system deployed across a plurality of separate geographical regions of the multi-region cloud service, the rolling-back is configured to support two operation modes:
a regional roll-back mode in which the at least one loosely-coupled service is rolled-back independently in at least one of the plurality of geographical regions, and
a global roll-back mode in which the at least one loosely-coupled service is rolled-back simultaneously in the plurality of geographical regions.

14. The method of claim 7, wherein managing resources for the at least one loosely-coupled service comprises at least one of:
converting Application Programming Interface (API) instructions to at least one declarative configuration file used by the container execution system,
instructing the container execution system to allocate at least one resource for the at least one loosely-coupled service, and
instructing the container execution system to release at least one resource allocated for the at least one loosely-coupled service.

15. The method of claim 7, wherein managing secrets for the at least one loosely-coupled service comprises at least one of:
instructing the container execution system to create at least one secret for use by the at least one loosely-coupled service, and
instructing the container execution system to provide each secret value relating to the at least one loosely-coupled service.

16. The method of claim 7, wherein managing services for the at least one loosely-coupled service comprises at least one of:
instructing the container execution system to initiate at least one service used by the at least one loosely-coupled service, and
instructing the container execution system to stop at least one service used by the at least one loosely-coupled service.

17. The method of claim 7, wherein initiating at least one script relating to the at least one loosely-coupled service comprises instructing the container execution system to initiate the at least one script.

18. The method of claim 1, wherein the GUI comprises a command line interface (CLI).

19. A system for creating loosely-coupled services automatically, comprising:
at least one processor configured to execute a code, the code comprising:
code instructions to instruct a graphical user interface (GUI), executed by at least one client device for interacting with at least one user, to present a command menu listing a plurality of high-level commands corresponding to a plurality of actions for controlling and managing an operation of at least one loosely-coupled service of a cloud service according to at least one of rules, templates and domain knowledge, wherein said controlling and managing comprise at least one of configuring, adjusting and operating said at least one loosely-coupled service, wherein the at least one loosely-coupled service is deployed as a container in a container execution system facilitating the cloud service;
code instructions to receive a selection of one of the plurality of high-level commands selected by the at least one user using the GUI;
code instructions to analyze at least one command inserted by the at least one user by said selection, to determine at least one of the plurality of actions corresponding to the at least one inserted command; and
code instructions to communicate with the container execution system via at least one network to instruct automatic execution of the corresponding at least one action with respect to the at least one loosely-coupled service deployed in the container execution system.

20. The method of claim 1, wherein said analyzing comprises identifying when an authentication of said at least one user is required, and wherein said method further comprising authenticating the at least one user according to said identification.
